(19) United States
(12) Patent Application Publication
(10) Pub. No.: US 2014/0072668 A1
(43) Pub. Date: Mar. 13, 2014

(54) MOLD AND MOLD BLANK SUBSTRATE

(71) Applicants: Ikuo YONEDA, Mie-ken (JP); Tetsuro Nakasugi, Kanagawa-Ken (JP)

(72) Inventors: Ikuo YONEDA, Mie-ken (JP); Tetsuro Nakasugi, Kanagawa-Ken (JP)

(21) Appl. No.: 13/731,617

(22) Filed: Dec. 31, 2012

(30) Foreign Application Priority Data
Sep. 7, 2012 (JP) 2012-197806

(51) Int. Cl. B29C 59/02

(52) U.S. Cl. CPC B29C 59/02
USPC 425/385; 428/157

(57) ABSTRACT

According to one embodiment, a mold includes a base material, a pedestal portion and a pattern portion. The base material includes a first surface and a second surface. The pedestal portion protruded from the first surface of the base material and includes a side surface. The pattern portion is provided in the pedestal portion and includes an concave-convex pattern. The pedestal portion includes a first region and a second region. The first region is provided with the concave-convex pattern. The second region is provided between the first region and the side surface. The second region has maximum height equal to maximum height of the first region. The second region has a first height of the second region on the side surface side and a second height of the second region on the first region side. The first height is lower than the second height.

### CROSS-REFERENCE TO RELATED APPLICATIONS

This application is based upon and claims the benefit of priority from the prior Japanese Patent Application No. 2012-197806, filed on Sep. 7, 2012; the entire contents of which are incorporated herein by reference.

### FIELD

Embodiments described herein relate generally to a mold and mold blank substrate.

### BACKGROUND

As a pattern formation method, the imprint method has been drawing attention. The imprint method uses a master (mold) provided with the concave-convex shape of a pattern to be formed. In the imprint method, a photocurable organic material, for instance, is applied onto a substrate. The layer of this organic material is brought into contact with the mold and cured by light irradiation. Thus, a pattern in which the concave-convex shape of the mold is transferred is formed in the layer of the organic material.

In the pattern formation method using a mold, in view of improving the yield, it is important to control the film thickness of the organic material at the time of pressing with the mold.

### BRIEF DESCRIPTION OF THE DRAWINGS

FIGS. 1A to 1C are schematic sectional views illustrating the configuration of a mold according to a first embodiment;

FIGS. 2A and 2B are schematic sectional views illustrating the pedestal portion;

FIGS. 3A to 3D are schematic sectional views illustrating the imprint method;

FIGS. 4A and 4B are schematic sectional views illustrating resist spreading;

FIGS. 5A to 5D are schematic sectional views showing examples of the shape of the pedestal portion;

FIGS. 6A to 6C are schematic sectional views illustrating the configuration of molds according to the second embodiment;

FIG. 7 is a flow chart illustrating the method for manufacturing a mold according to the third embodiment;

FIGS. 8A and 8B are schematic sectional views illustrating the manufacturing of a mold;

FIG. 9 is a flow chart illustrating the method for manufacturing a mold according to the fourth embodiment; and

FIGS. 10A and 10B are schematic sectional views illustrating the manufacturing of a mold.

### DETAILED DESCRIPTION

In general, according to one embodiment, a mold includes a base material, a pedestal portion and a pattern portion. The base material includes a first surface and a second surface on opposite side from the first surface. The pedestal portion protruded from the first surface of the base material. The pedestal portion includes a side surface. The pattern portion is provided in the pedestal portion. The pattern portion includes an concave-convex pattern. The pedestal portion includes a first region and a second region. The first region is provided with the concave-convex pattern. The second region is provided between the first region and the side surface. The second region has maximum height equal to maximum height of the first region. The second region has a first height of the second region on the side surface side and a second height of the second region on the first region side. The first height is lower than the second height.

Various embodiments will be described hereinafter with reference to accompanying drawings. In the following description, like members are labeled with like reference numerals. The description of the members once described is omitted appropriately.

### First Embodiment

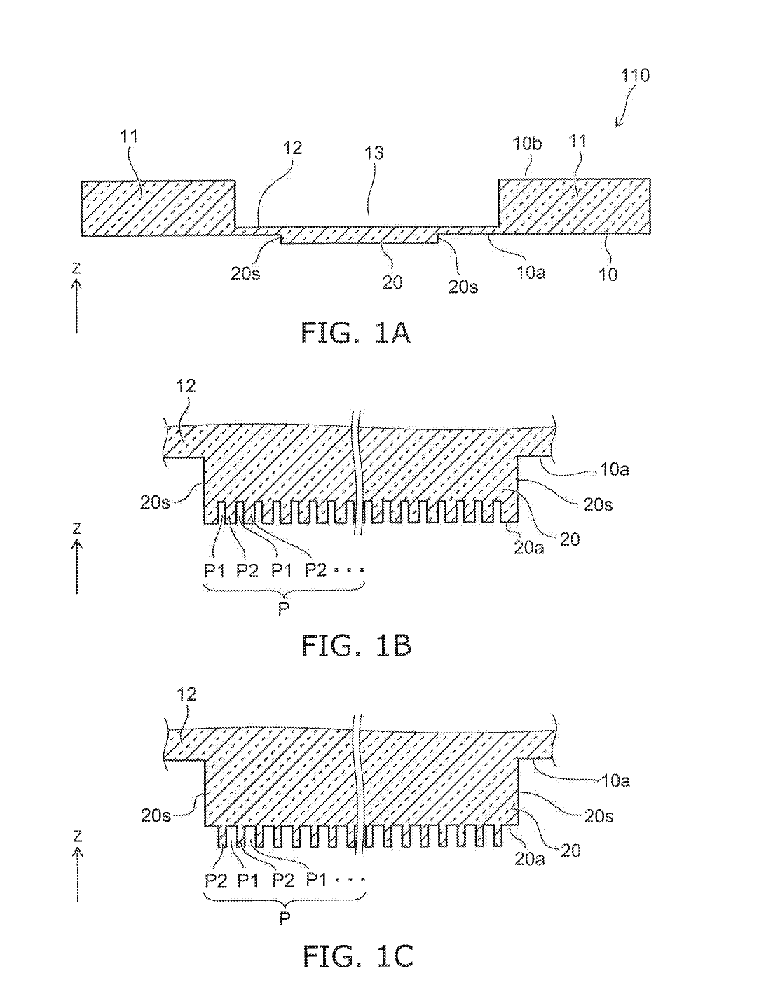

FIGS. 1A to 1C are schematic sectional views illustrating the configuration of a mold according to a first embodiment.

FIG. 1A shows a schematic sectional view illustrating a general overview of the mold 110. FIGS. 1B and 1C show schematic sectional views in which the pattern portion P is enlarged.

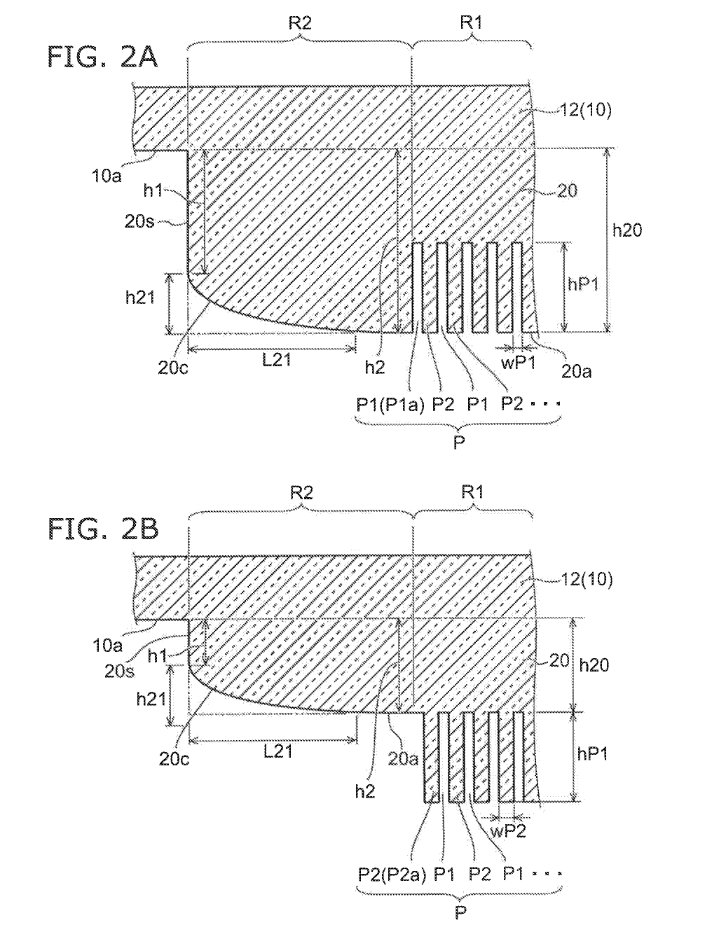

FIGS. 2A and 2B are schematic sectional views illustrating the pedestal portion.

FIG. 2A shows a schematic sectional view in which part of the pedestal portion shown in FIG. 1A is enlarged. FIG. 2B shows a schematic sectional view in which part of the pedestal portion shown in FIG. 1B is enlarged.

As shown in FIG. 1A, the mold 110 according to this embodiment includes a base material 10, a pedestal portion 20, and a pattern portion P. The mold 110 is a master used to form a pattern by the imprint method.

The base material 10 includes a first surface 10a and a second surface 10b. The second surface 10b is a surface on the opposite side from the first surface 10a. In this embodiment, the direction connecting the first surface 10a and the second surface 10b is referred to as Z direction. The Z direction is also the thickness direction of the base material 10. The base material 10 is made of e.g. a light transmissive material. The material of the base material 10 is e.g. quartz.

In the mold 110 according to this embodiment, a recess portion 13 is provided in the base material 10. The recess 13 is a portion of the base material 10 set back in the Z direction from the second surface 10b. The recess portion 13 is provided in a central portion 12 of the base material 10. The base material 10 includes a peripheral portion 11 around the central portion 12. The peripheral portion 11 is provided like a frame so as to surround the outer periphery of the base material 10. The recess portion 13 is provided in the central portion 12 of the base material 10 in e.g. a circular shape as viewed in the Z direction.

The outline of the base material 10 as viewed in the Z direction is e,g. a rectangle. The size of the outline of the base material 10 as viewed in the Z direction is e.g. 150 millimeters (mm) long and 150 mm wide. The thickness of the peripheral portion 11 is e.g. 6.4 mm. The thickness of the central portion 12 is e.g. 1 mm.

The pedestal portion 20 is protruded from the first surface 10a of the base material 10. The pedestal portion 20 includes a side surface 20s. The side surface 20s is a surface extending in the Z direction. For instance, the pedestal portion 20 is provided integrally with the base material 10. The pedestal portion 20 may be provided separately from the base material 10. The outline of the pedestal portion 20 as viewed in the Z direction is e.g. a rectangle. The size of the outline of the pedestal portion 20 as viewed in the Z direction is e.g. 33 mm long and 26 mm wide. The height of the pedestal portion 20 is e.g. 3 micrometers (μm).

As shown in FIGS. 1B and 1C, the pattern portion P includes a concave pattern P1 and a convex pattern P2 (concave-convex pattern) provided in the pedestal portion 20. The pattern portion P shown in FIG. 1B is a pattern including a concave pattern P1 on the outermost side. In this pattern portion P, the concave pattern P1 is set back in the Z direction from the surface 20a of the pedestal portion 20. The surface 20a of the pedestal portion 20 is a reference surface of the concave-convex pattern. In the case where a plurality of concave patterns P1 are juxtaposed, the portion between two adjacent concave patterns P1 constitutes a convex pattern P2. In the pattern portion P shown in FIG. 1B, the pattern P is provided inside the pedestal portion 20.

The pattern portion P shown in FIG. 1C is a pattern including a convex pattern P2 on the outermost side. In this pattern portion P, the convex pattern P2 is protruded in the Z direction from the surface 20a of the pedestal portion 20. In the case where a plurality of convex patterns P2 are juxtaposed, the portion between two adjacent convex patterns P2 constitutes a concave pattern P1. In the pattern portion P shown in FIG. 1C, the pattern P is provided outside the pedestal portion 20.

As shown in FIGS. 2A and 2B, the pedestal portion 20 includes a first region R1 and a second region R2. The first region R1 is a region provided with the concave-convex pattern of the pedestal portion 20. The first region R1 is a region of the pedestal portion 20 overlapping the pattern portion P in the Z direction. The second region R2 is a region provided between the first region R1 and the side surface 20s, The second region R2 is a region of the pedestal portion 20 not overlapping the pattern portion P in the Z direction.

The maximum height of the first region R1 is equal to the maximum height of the second region R2. Here, the height refers to the height in the Z direction with reference to the first surface 10a. The term “equal” includes being substantially equal

In the mold 110 according to this embodiment, the first height h1 of the second region R2 on the side surface 20s side is lower than the second height h2 of the second region R2 on the first region R1 side. Here, the heights h1 and h2 are heights in the Z direction with reference to the extended surface of the first surface 10a.

In the example shown in FIG. 2A, the second height h2 is equal to the height at the position of the opening end of the concave pattern P1a. The concave pattern P1a is a concave pattern P1 nearest to the second region R2 in the pattern portion P. The second height h2 is equal to e.g. the height h20 of the pedestal portion 20. The first height h1 is equal to e.g. the height of the side surface 20s.

In the example shown in FIG. 2B, the second height h2 is equal to the height at the position of the root of the convex pattern P2a. The convex pattern P2a is a convex pattern P2 nearest to the second region R2 in the pattern portion P. The second height h2 is equal to e.g. the height h20 of the pedestal portion 20. The first height h1 is equal to e.g. the height of the side surface 20s.

The difference between the second height h2 and the first height h1 is smaller than the step difference of the concave-convex pattern. For instance, in the example shown in FIG. 2A, the difference between the second height h2 and the first height h1 is smaller than the depth hP1 of the concave pattern P1. For instance, in the example shown in FIG. 2B, the difference h21 between the second height h2 and the first height h1 is smaller than the height hP2 of the convex pattern P2.

In the examples shown in FIGS. 2A and 2B, the second region R2 includes a curved surface 20c curved in a convex shape from the first region R1 to the side surface 20s. Because the curved surface 20c is provided, the shoulder part of the pedestal portion 20 has a rounded shape.

The shoulder part of the pedestal portion 20 is the outermost part to be brought into contact with a resist (photosensitive organic material) to which the mold 110 is pressed in the imprint method described later. The height of the second region R2 is gradually lowered from the first region R1 side toward the side surface 20s side.

In the example shown in FIG. 2A, the depth hP1 of the concave pattern P1 is e.g. 10 nanometers (nm) or more and 100 nm or less. The opening width wP1 of the concave pattern P1 is e.g. 5 nm or more. In the example shown in FIG. 2B, the height hP2 of the convex pattern P2 is e.g. 10 nm or more and 100 nm or less. The width wP2 of the convex pattern P2 is e.g. 5 nm or more.

The difference h21 between the second height h2 and the first height h1 is e.g. 10 nm or more and 50 nm or less. The length of the part with the changing height of the second region R2 (the length L21 in the direction parallel to the first surface 10a) is e.g. 5 mm. In the examples shown in FIGS. 2A and 2B, the length L21 of the part provided with the curved surface 20c is e.g. 5 mm.

The difference h21 between the second height h2 and the first height h1 is measured by e.g. a step gauge or AFM (atomic force microscope).

The mold 110 according to this embodiment includes the pedestal portion 20 as described above. Thus, when the mold 110 is pressed to a resist in the imprint method described later, running off of the resist to the outside of the side surface 20s of the pedestal portion 20 is suppressed. For instance, the shoulder part of the pedestal portion 20 is rounded. Thus, compared with the case where the shoulder part is not rounded, a space for receiving the resist is formed. This suppresses running off of the resist to the outside of the side surface 20s.

Here, an imprint method using the mold 110 is described.

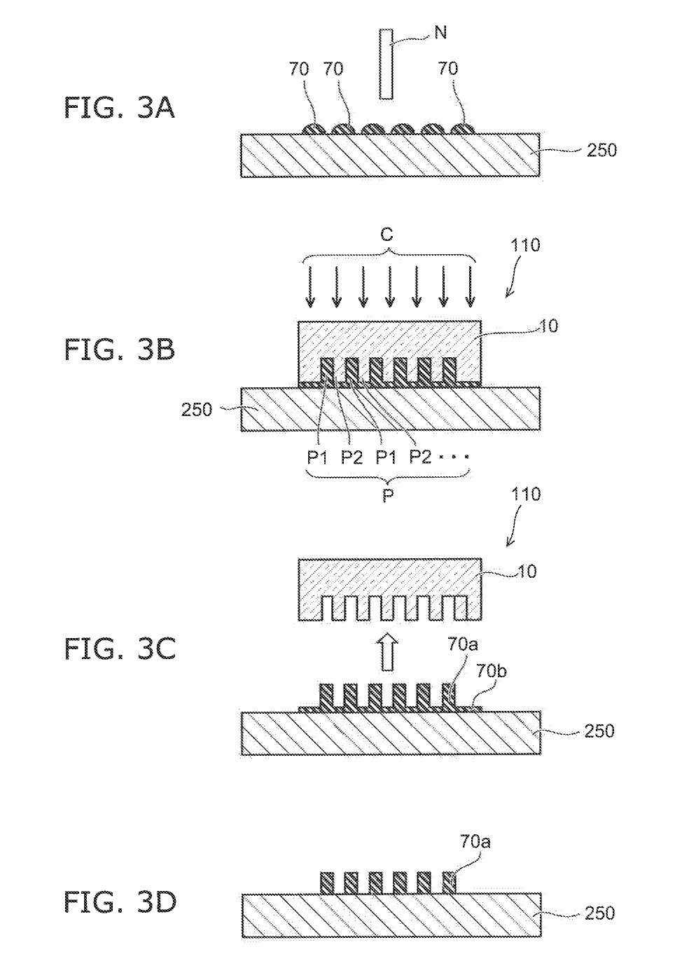

FIGS. 3A to 3D are schematic sectional views illustrating the imprint method.

FIGS. 3A to 3D schematically show an example of forming a pattern using the mold 110 according to this embodiment.

First, as shown in FIG. 3A, a resist 70 of photosensitive organic material is applied onto a substrate 250. The resist 70 is applied onto the substrate 250 by e.g. the ink jet method from a nozzle N. The size of the droplet of the resist 70 is e.g. approximately several μm. The spacing between the droplets of the resist 70 is e.g. 10 μm or more and 100 μm or less. Here, the resist 70 may be applied with a uniform thickness onto the substrate 250 by e.g. spin coating.

Next, as shown in FIG. 3B, the mold 110 according to this embodiment is prepared. Then, the pattern portion P of this mold 110 is brought into contact with the resist 70. The resist 70 is penetrated into the concave pattern P1 by capillarity. The resist 70 is embedded in the concave pattern P1.

Next, with the pattern portion P of the mold 110 brought into contact with the resist 70, light C is applied from the base material 10 side of the mold 110. The light C is e.g. ultraviolet light. The light C is transmitted through the base material 10 and the pattern portion P and applied to the resist 70. The resist 70 is cured by irradiation with the light C.

Next, as shown in FIG. 3C, the mold 110 is released from the resist 70. Thus, a transfer pattern 70a in which the concave-convex shape of the pattern portion P of the mold 110 is transferred is formed on the substrate 250. When the mold 110 is brought into contact with the resist 70, a slight gap is provided between the mold 110 and the substrate 250. The resist 70 penetrated into this gap remains as a residual film 70b after curing.

Next, processing for removing this residual film 70b is performed. For instance, the transfer pattern 70a and the residual film 70b are etched back by RIE (reactive ion etching). Thus, as shown in FIG. 3D, only the transfer pattern 70a remains on the substrate 250.

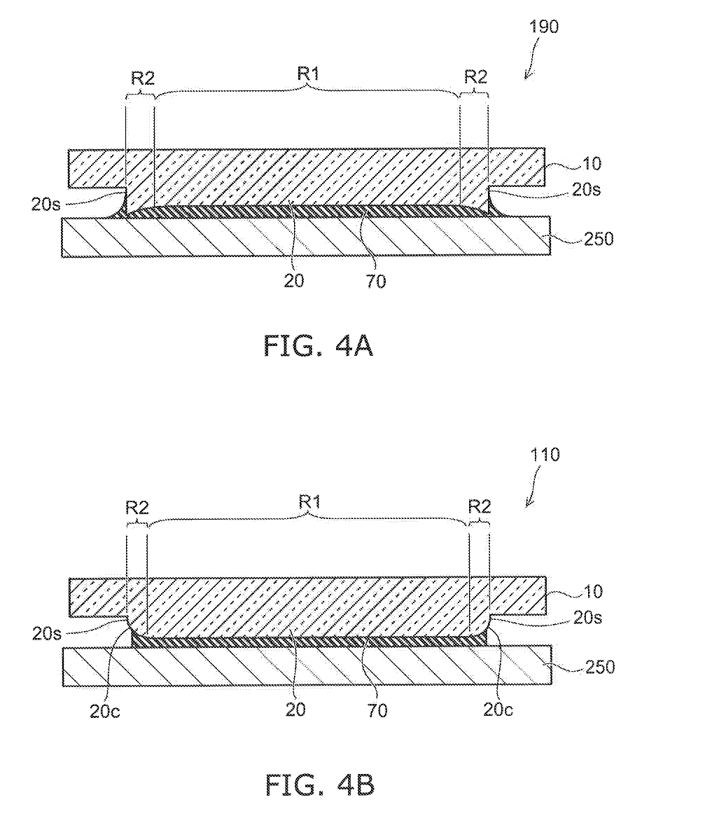

FIGS. 4A and 4B are schematic sectional views illustrating resist spreading.

FIG. 4A illustrates resist spreading in the case of using a mold 190 according to a reference example. FIG. 4B illustrates resist spreading in the case of using the mold 110 according to this embodiment.

In the mold 190 according to the reference example shown in FIG. 4A, the height of the second region R2 is constant. In the mold 190, the shoulder part of the pedestal portion 20 is not rounded. In the imprint method, at the early stage of bringing the mold 190 into contact with the resist 70, a pressure is applied to the mold 190 so that the central portion of the mold 190 has a downward convex shape. After the central portion of the mold 190 is brought into contact with the resist 70, the pressure applied to the mold 190 is released. Thus, the resist 70 filled in between the mold 190 and the substrate 250 is spread from the central portion toward the peripheral portion of the mold 190.

At the time of application and release of pressure to the mold 190, the mold 190 may vibrate, and the pedestal portion 20 may warp in a downward concave shape. This warpage results in decreasing the distance between the outer edge portion of the pedestal portion 20 and the substrate 250. At this time, the resist 70 may run off to the outside of the outer edge portion of the pedestal portion 20. The resist 70 having run off to the outside climbs up the side surface 20s of the pedestal portion 20 by surface tension. If the resist 70 climbs up along the side surface 20s, its reaction causes the outer edge portion of the pedestal portion 20 to warp further downward. This results in further running off of the resist 70.

The warpage of the mold 190 affects the shape and orientation of the transfer pattern 70a. Furthermore, the warpage of the mold 190 affects the releasability of the mold 190. Deterioration of releasability imposes an excessive load on the transfer pattern 70a. Excessive load on the transfer pattern 70a causes damage to the transfer pattern 70a.

In the mold 110 according to this embodiment shown in FIG. 4B, the second region R2 is provided with a curved surface 20c and the like. If a transfer pattern 70a is formed by the imprint method using the mold 110, then despite any vibration of the mold 110, the outer edge portion of the pedestal portion 20 does not unnecessarily come close to the substrate 250. Thus, the resist 70 spread from the central portion to the peripheral portion of the mold 110 does not run off to the outside of the side surface 20s.

Because the resist 70 does not run off to the outside, the resist 70 does not climb up along the side surface 20s. The resist 70 climbs up along the curved surface 20c. However, the Z-direction component of the reaction is smaller than in the case where the resist 70 climbs up along the side surface 20s. Accordingly, the amount of warpage of the mold 110 is small.

Thus, use of the mold 110 according to this embodiment suppresses running off of the resist 70 and warpage of the mold 110 in the imprint method. Accordingly, a transfer pattern 70a is formed accurately in position and direction. When the mold 110 is released, no excessive load is imposed on the transfer pattern 70a. This suppresses damage to the transfer pattern 70a at the time of releasing the mold 110. Thus, the yield of pattern formation is improved.

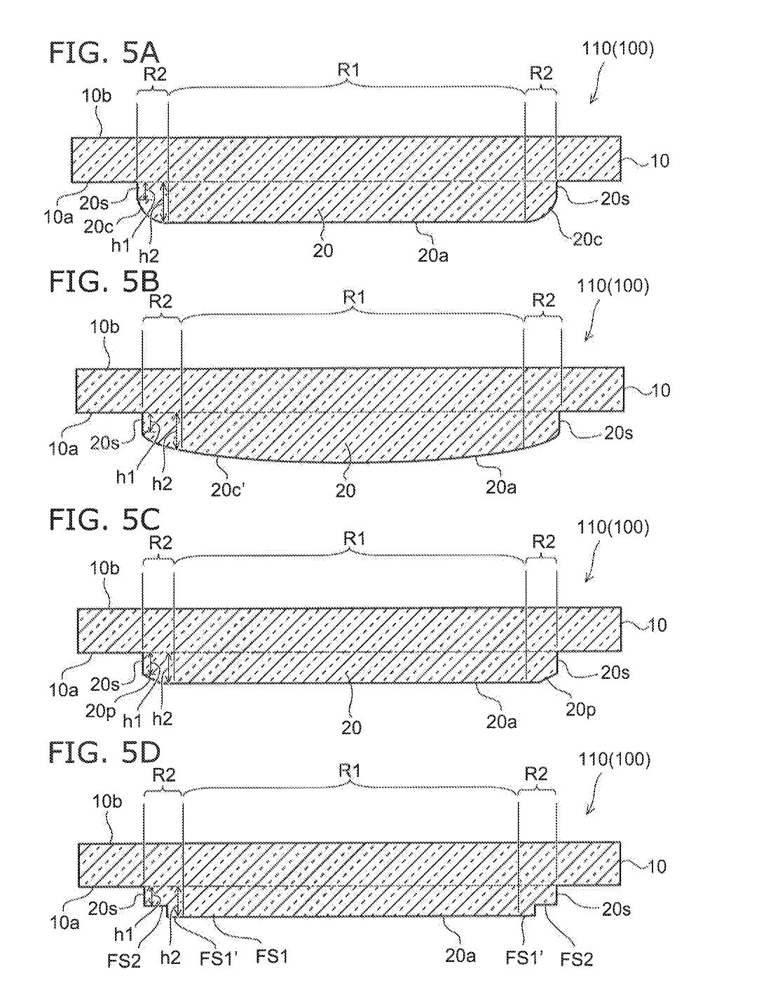

FIGS. 5A to 5D are schematic sectional views showing examples of the shape of the pedestal portion.

FIGS. 5A to 5D schematically show the outline of the pedestal portion, with the concave-convex pattern of the pattern portion P omitted.

In the example shown in FIG. 5A, like the example shown in FIGS. 2A and 2B, a curved surface 20c is provided at the surface of the second region R2. The curved surface 20c is provided from the first region R1 side to the side surface 20s of the second region R2. The curved surface 20c may be provided either partly or entirely along the outer periphery of the pedestal portion 20.

Preferably, the curved surface 20c is provided at least in the corner portion of the pedestal portion 20 as viewed in the Z direction. In the corner portion, the resist 70 spread is likely to run off. If the curved surface 20c is provided in the corner portion, running off of the resist 70 is effectively suppressed.

In the example shown in FIG. 5B, the surface 20a of the pedestal portion 20 includes a curved surface 20c′. The curved surface 20c′ is curved in a convex shape in the direction away from the first surface 10a from the first region R1 to the second region R2. That is, the surface 20a of the pedestal portion 20 is entirely curved in a downward convex shape. The curved surface 20c″ may be curved either cylindrically or spherically.

The surface of the second region R2 of the pedestal portion 20 shown in FIG. 5C includes an inclined surface 20p inclined with respect to the first surface 10a from the first region R1 side to the side surface 20s of the second region R2. The inclined surface 20p may be provided either partly or entirely along the outer periphery of the pedestal portion 20.

Preferably, the inclined surface 20p is provided at least in the corner portion of the pedestal portion 20 as viewed in the Z direction. In the corner portion, the resist 70 spread is likely to run off. If the inclined surface 20p is provided in the corner portion, running off of the resist 70 is effectively suppressed.

The first region R1 of the pedestal portion 20 shown in FIG. 5D includes a first flat surface FS1 parallel to the first surface 10a. Here, the term “parallel” includes being substantially parallel. The second region R2 includes a flat surface FS1′ parallel to the first surface 10a, and a second flat surface FS2 parallel to the first surface 10a. The flat surface FS1′ is a surface continued to the first flat surface FS1. The second flat surface FS2 is a surface not continued to the first flat surface FS1.

The second region R2 includes a step difference between the flat surface FS1′ and the second flat surface FS2. In imprinting, the resist 70 spread enters into a space formed by the aforementioned step difference of the second region R2. This suppresses running off of the resist 70 to the outside of the side surface 20s of the pedestal portion 20.

In any mold 110 of FIGS. 5A to 5D, the first height h1 of the second region R2 on the side surface 20s side is lower than the second height h2 of the second region R2 on the first region R1 side.

The shape of the pedestal portion 20 shown in FIGS. 5A to 5D is also applicable to a mold blank substrate 100 with no pattern portion P provided in the pedestal portion 20. The mold blank substrate 100 includes a base material 10 and a pedestal portion 20. The base material 10 includes a first surface 10a. The pedestal portion 20 is protruded from the first surface of the base material 10. The pedestal portion 20 includes a side surface 20s. The pedestal portion 20 includes a first region R1, and a second region R2 provided between the first region R1 and the side surface 20s. The maximum height of the first region R1 is equal to the maximum height of the second region R2. The first height of the second region R2 on the side surface 20s side is lower than the second height of the second region R2 on the first region R1 side. As a configuration in which the first height of the second region R2 is made lower than the second height, the shape of the pedestal portion 20 shown in FIGS. 5A to 5D is applied,

### Second Embodiment

Next, a mold according to a second embodiment is described.

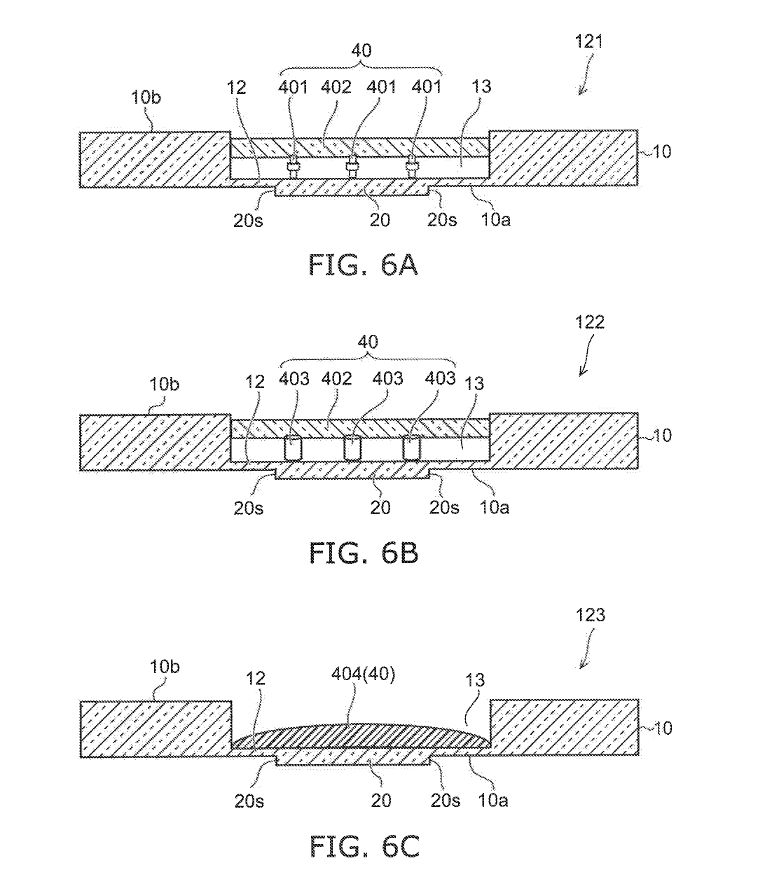

FIGS. 6A to 6C are schematic sectional views illustrating the configuration of molds according to the second embodiment.

The molds 121, 122, and 123 shown in FIGS. 6A, 6B, and 6C include a base material 10, a pedestal portion 20, a pattern portion P, and a damping portion 40. The central portion 12 of the base material 10 is provided between the pedestal portion 20 and the damping portion 40. The damping portion 40 has the function of suppressing the vibration of the pedestal portion 20.

The damping portion 40 shown in FIG. 6A includes a vibration damper 401 and a support portion 402. The support portion 402 is provided in the recess portion 13 of the base material 10. The support portion 402 is spaced from the central portion 12. The support portion 402 is fitted between the opposed sidewalk of the recess portion 13. The vibration damper 401 is provided between the support portion 402 and the central portion 12. The vibration damper 401 may be provided in a plurality.

In the mold 121, the thickness of the central portion 12 is thinner than the thickness of the peripheral portion 11. Thus, the central portion 12 is easy to warp. In the imprint method, a pressure is applied from the recess portion 13 to the central portion 12 to warp the central portion 12. Thus, the pedestal portion 20 is turned to a downward convex shape.

In this state, the center of the pattern portion P is brought into contact with a resist 70. Then, the pressure applied to the central portion 12 is gradually released. Thus, the contact region of the pattern portion P and the resist 70 is spread from the center toward the periphery. By such a method, mixing of air bubbles between the pattern portion P and the resist 70 is suppressed.

In this imprint method, application and release of pressure to the central portion 12 may cause vibration in the central portion 12. If the central portion 12 vibrates, the resist 70 is made likely to run off to the outside of the side surface 20s of the pedestal portion 20. In the mold 121, vibration of the central portion 12 is suppressed by the vibration damper 401. In the mold 121, because vibration of the central portion 12 is suppressed, running off of the resist 70 due to vibration is suppressed.

The damping portion 40 shown in FIG. 6B includes a pillar portion 403 and a support portion 402. The pillar portion 403 includes a damping material. The damping material is e.g. porous glass or gel-like elastomer.

The pillar portion 403 is provided between the support portion 402 and the central portion 12. The pillar portion 403 may be provided in a plurality. The pillar portion 403 is a member shaped like a pillar from a damping material. In the mold 122, vibration of the central portion 12 is suppressed by the pillar portion 403. The pillar portion 403 achieves a damping effect with a simpler structure than the vibration damper 401.

The damping portion 40 shown in FIG. 6C includes a cover portion 404. The cover portion 404 is provided in the recess portion 13. The cover portion 404 is provided so as to cover the bottom portion of the recess portion 13. The cover portion 404 includes a damping material. The damping material is e.g. porous glass or gel-like elastomer.

In the mold 123, vibration of the central portion 12 is suppressed by the cover portion 404. In the mold 123, the damping portion 40 does not need the support portion 402. The mold 123 achieves a damping effect with a simple configuration of only the cover portion 404.

### Third Embodiment

Next, a method for manufacturing a mold according to a third embodiment is described.

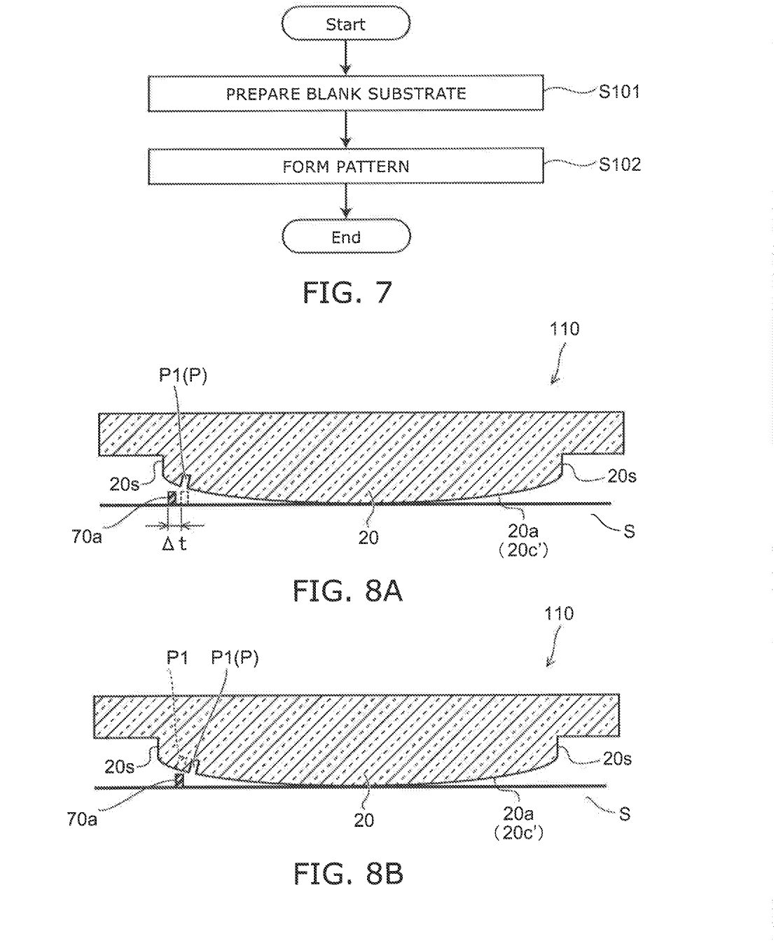

FIG. 7 is a flow chart illustrating the method for manufacturing a mold according to the third embodiment.

FIGS. 8A and 8B are schematic sectional views illustrating the manufacturing of a mold.

As shown in FIG. 7, the method for manufacturing a mold according to this embodiment includes the steps of preparing a blank substrate (step S101) and forming a pattern (step S102).

In the step of preparing a blank substrate (step S101), a mold blank substrate 100 including a convex curved surface 20c′ in the pedestal portion 20 is prepared.

In the step of forming a pattern (step S102), a pattern is formed on the curved surface 20c′ of the pedestal portion 20 laid along a flat surface and matched with a reference position on the flat surface.

FIG. 8A schematically shows an example of pattern transfer in the case of using the mold according to this embodiment. As in the mold 110 illustrated in FIG. 5B, for instance, the mold 110 shown in FIG. 8A includes a curved surface 20c′ in the surface 20a of the pedestal portion 20. FIG. 8A illustrates a case of performing pattern transfer using the mold 110 in which a concave pattern P1 is provided in the curved part. In the case of using this mold 110 to form a transfer pattern 70a on the flat surface of a substrate 5, the curved surface 20c′ of the mold 110 lies along the flat surface of the substrate S. Thus, the transfer pattern 70a formed on the flat surface of the substrate S is provided more outside than in the case where the pedestal portion 20 is flat. The amount of displacement of the transfer pattern 70a is denoted by Δt.

In the method for manufacturing the mold 110 according to this embodiment, a pattern portion P is formed in the pedestal portion 20 including a curved surface 20C. In this formation, the amount of displacement Δt of the transfer pattern 70a shown in FIG. 8A is taken into consideration.

As shown in FIG. 8B, a pattern portion P is formed in the pedestal portion 20 including a convex curved surface 20c′. In this case, the curved surface 20c′ of the pedestal portion 20 is laid along the flat surface of the substrate S. Then, the pattern is formed on the curved surface 20c′ matched with a reference position on the flat surface. Specifically, for instance, a concave pattern P1 is formed on the curved surface 20c′. In this case, the formation position of the concave pattern P1 is adjusted inward so as to eliminate the amount of displacement Δt of the transfer pattern 70a. Alternatively, the pattern portion P may be formed with the mold blank substrate 100 warped so that the curved surface 20c′ is made flat.

Thus, in the case of performing pattern formation using the mold 110 in which a pattern portion P is provided in the pedestal portion 20 including a curved surface 20c′, a transfer pattern is formed at a position as designed.

### Fourth Embodiment

Next, a method for manufacturing a mold according to a fourth embodiment is described.

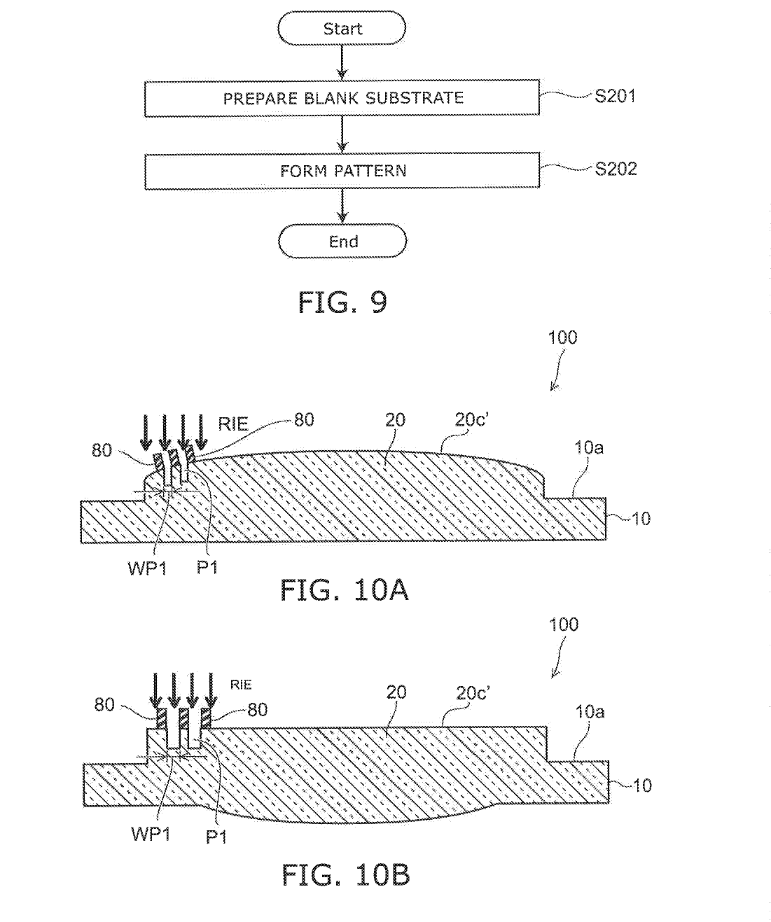

FIG. 9 is a flow chart illustrating the method for manufacturing a mold according to the fourth embodiment.

FIGS. 10A and 10B are schematic sectional views illustrating the manufacturing of a mold.

As shown in FIG. 9, the method for manufacturing a mold according to this embodiment includes the steps of preparing a blank substrate (step S201) and forming a pattern (step S202).

In the step of preparing a blank substrate (step S201), a mold blank substrate 100 including a convex curved surface 20c′ in the pedestal portion 20 is prepared.

In the step of forming a pattern (step S202), a pattern is formed on the curved surface 20c′ with the mold blank substrate 100 warped so that the curved surface 20c′ of the pedestal portion 20 is made flat.

FIG. 10A schematically shows an example of forming a concave pattern P1 in the curved surface 20c″ of the pedestal portion 20. To form a concave pattern P1 in the curved surface 20c′, a mask material 80 is formed on the curved surface 20c′. Then, the pedestal portion 20 is etched by e.g. RIE. Here, the mask material 80 is provided perpendicular to the curved surface 20c′. That is, the mask material 80 is inclined with respect to the direction normal to the first surface 10a.

The opening width of the mask material 80 as viewed in the direction normal to the first surface 10a is narrower than the opening width of the mask material 80 as viewed in the direction normal to the curved surface 20c′. In this state, RIE is performed in the direction perpendicular to the first surface 10a. Then, reactive ions impinge obliquely on the mask material 80. Accordingly, the opening width wP1 of the concave pattern P1 formed in the pedestal portion 20 is made narrower than the planned opening width (the opening width of the mask material 80).

Thus, as shown in FIG. 10B, in this embodiment, RIE is performed with the mold blank substrate 100 warped so that the curved surface 20c′ of the pedestal portion 20 is made flat. Hence, the opening width of the mask material 80 as viewed in the direction normal to the first surface 10a is made substantially equal to the opening width of the mask material 80 as viewed in the direction normal to the curved surface 20c′. Accordingly, the opening width wP1 of the concave pattern P1 formed in the pedestal portion 20 is made substantially equal to the planned opening width (the opening width of the mask material 80).

By performing pattern transfer using the mold 110 thus formed, a transfer pattern is formed at a position as designed.

As described above, the mold, the mold blank substrate, and the method for manufacturing a mold according to the embodiments can form a pattern with high yield.

The embodiments and the variations thereof have been described above. However, the invention is not limited to these examples. For instance, those skilled in the art can modify the above embodiments or the variations thereof by suitable addition, deletion, and design change of components, and by suitable combination of the features of the embodiments. Such modifications are also encompassed within the scope of the invention as long as they fall within the spirit of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A mold comprising:
a base material including a first surface and a second surface on opposite side from the first surface;
a pedestal portion protruded from the first surface of the base material, the pedestal portion including a side surface; and
a pattern portion provided in the pedestal portion and including an concave-convex pattern,
the pedestal portion including:
a first region provided with the concave-convex pattern; and
a second region provided between the first region and the side surface, the second region having maximum height equal to maximum height of the first region, the second region having a first height of the second region on the side surface side and a second height of the second region on the first region side,
the first height being lower than the second height.

2. The mold according to claim 1, wherein
the base material includes a recess portion provided in a central portion of the base material and set back from the second surface, and
the pedestal portion is provided in a region overlapping the recess portion as viewed in thickness direction of the base material.

3. The mold according to claim 1, wherein a surface of the second region includes a curved surface.

4. The mold according to claim 3, wherein the curved surface is provided entirely along outer periphery of the pedestal portion.

5. The mold according to claim 1, wherein a reference surface of the concave-convex pattern in the pedestal portion is curved in a convex shape in a direction away from the first surface.

6. The mold according to claim 1, wherein a surface of the second region includes an inclined surface inclined with respect to the first surface from the first region side to the side surface of the second region.

7. The mold according to claim 1, wherein
the first region includes a first flat surface parallel to the first surface, and
the second region includes a flat surface being parallel to the first surface and continued to the first flat surface, and a second flat surface being parallel to the first surface and not continued to the first flat surface.

8. A mold comprising:
a base material including a first surface;
a pedestal portion protruded from the first surface of the base material;
a pattern portion provided in the pedestal portion and including an concave-convex pattern; and
a damping portion configured to suppress vibration of the pedestal portion.

9. The mold according to claim 8, wherein the base material is provided between the pedestal portion and the damping portion.

10. The mold according to claim 8, wherein the damping portion includes a buffering device.

11. The mold according to claim 8, wherein the damping portion includes a buffering material.

12. A mold blank substrate comprising:
a base material including a first surface; and
a pedestal portion protruded from the first surface of the base material and including a side surface,
the pedestal portion including:
a first region; and
a second region provided between the first region and the side surface, the second region having maximum height equal to maximum height of the first region, the second region having a first height of the second region on the side surface side and a second height of the second region on the first region side,
the first height being lower than the second height.

13. The substrate according to claim 12, wherein a surface of the second region includes a curved surface,

14. The substrate according to claim 12, wherein a surface of the pedestal portion includes a curved surface curved in a convex shape in a direction away from the first surface,

15. The substrate according to claim 12, wherein a surface of the second region includes an inclined surface inclined with respect to the first surface from the first region side to the side surface of the second region,

16. The substrate according to claim 12, wherein
the first region includes a first flat surface parallel o the first surface, and
the second region includes a flat surface being parallel to the first surface and continued to the first flat surface, and a second flat surface being parallel to the first surface and not continued to the first flat surface.
